(19) United States
(12) Patent Application Publication
(10) Pub. No.: US 2024/0109572 A1
(43) Pub. Date: Apr. 4, 2024

(54) CONFIGURABLE BAKER'S DOLLY

(71) Applicant: Perfect Site LLC, Las Vegas, NV (US)

(72) Inventor: Jared W. Hanlon, Las Vegas, NV (US)

(21) Appl. No.: 18/374,136

(22) Filed: Sep. 28, 2023

Related U.S. Application Data
(60) Provisional application No. 63/411,435, filed on Sep. 29, 2022.

(51) Int. Cl. B62B 3/02; B62B 3/00; B62B 5/06

(52) U.S. Cl. CPC B62B 3/02; B62B 3/005; B62B 5/06

(57) ABSTRACT

A baker's dolly includes a plurality of racks and at least one coupling member. The racks each include a shelf portion and a plurality of casters coupled to the shelf portion. The racks include a first rack and a second rack. The coupling member couples the first rack to the second rack in order to allow each of the first and second racks to each be rolled in a common horizontal plane.

### RELATED APPLICATION DATA

This application claims priority to U.S. Provisional Application Ser. No. 63/411,435, filed Sep. 29, 2022, which are incorporated in their entirety by reference herein.

### FIELD OF THE INVENTION

The present invention relates to movable racks such as a baker's dolly.

### BACKGROUND OF THE INVENTION

Baker's dollies are well known in the art. Such apparatus are typically employed in order to transport loads. For example, rather than users having to pick up loads (e.g., bags of food in the case of a bakery, but other items in other environments) and transport them by hand, a baker's dolly allows a user the opportunity to place the loads on a rack, and wheel the rack in a simple and easy manner. Further, baker's dollies often are provided with multiple levels of racks, thereby allowing many loads to be transported with one dolly. However, current baker's dollies are undesirably limited in several key respects.

First, while baker's dollies are configured to transport several loads that are stacked on top of one another, this is typically the only manner in which multiple loads can be transported via a single baker's dolly. As a result, users who wish to transport bigger loads are presented with relatively limited options. Second, it is common that baker's dollies are not provided with mechanisms to allow single racks or stacks of racks to be easily rolled. That is, these dollies generally have to be moved by directly pushing and pulling the transported load (e.g., the bags of food).

It is with respect to these and other considerations that the instant disclosure is concerned.

### SUMMARY OF THE INVENTION

One aspect of the invention is directed to a baker's dolly. In one embodiment, the baker's dolly comprises at least one rack which defines a support or shelf portion. The rack may include one or more universal mounts, such as for accepting casters for rollably supporting the rack, a handle for moving the rack, and/or coupling members which permit one rack to be coupled to another rack.

In this regard, in accordance with another embodiment of the invention, the baker's dolly comprises a plurality of racks, each comprising a shelf portion and a plurality of casters coupled to the shelf portion, the plurality of racks comprising a first rack and a second rack; and at least one coupling member coupling the first rack to the second rack in order to allow each of the first and second racks to each be rolled in a common horizontal plane.

In accordance with another embodiment, the baker's dolly comprises a caster comprising a wheel, a member coupled to the wheel, and a bolt coupled to the member; a rack coupled to the caster, the rack having a mounting portion; and an interconnect assembly. The interconnect assembly comprises an insert configured to receive the bolt therethrough and extend partially into the mounting portion, the insert comprising a body portion and a rim extending radially outwardly from the body portion, and a nut configured to receive the bolt therethrough and extend partially into the mounting portion, the nut comprising a body portion and a rim extending radially outwardly from the body portion of the nut. The rim of the insert and the rim of the nut are disposed parallel to one another in order to receive the mounting portion therebetween and be coupled thereto.

A further aspect of the invention is directed to an interconnect assembly for the aforementioned baker's dolly.

Further objects, features, and advantages of the present invention over the prior art will become apparent from the detailed description of the drawings which follows, when considered with the attached figures.

### DESCRIPTION OF THE DRAWINGS

FIG. 1 is an isometric view of a rack and coupling member for a baker's dolly, in accordance with one non-limiting aspect of the disclosed concept;

FIG. 2 is a partially exploded isometric view of the rack and coupling member of FIG. 1, shown coupled to other racks of the baker's dolly;

FIG. 3A shows an enlarged view of a portion of the baker's dolly of FIG. 2;

FIG. 3B is an isometric view of a handle coupled to a rack of the baker's dolly;

FIG. 3C shows multiple portions of the baker's dolly packed together;

FIGS. 4, 5A and 5B show different views of portions of a baker's dolly, coupled together, with other coupling members;

FIGS. 6A-6E show different views of a coupling member for the baker's dolly, with FIG. 6C showing the coupling member coupled to portions of two different racks of the baker's dolly;

FIGS. 7A-7D show assembled isometric, exploded isometric, exploded section, and assembled section views, respectively, of a portion of a baker's dolly and interconnect assembly therefor;

FIGS. 8A-8B shown isometric and exploded isometric views, respectively, of a portion of a baker's dolly and another interconnect assembly therefor;

FIG. 8C shows an exploded isometric view of a portion of another interconnect assembly;

FIGS. 9A and 9B show a rack coupled to a handle of a baker's dolly, and a coupling for the baker's dolly, respectively;

FIGS. 9C and 9D show assembled and exploded isometric views, respectively, of a portion of baker's dolly including a handle and a collar configured to be coupled to the interconnect assembly of FIGS. 8A and 8B; and

FIG. 9E shows a section view of a collar for the handle of FIGS. 9C and 9D.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

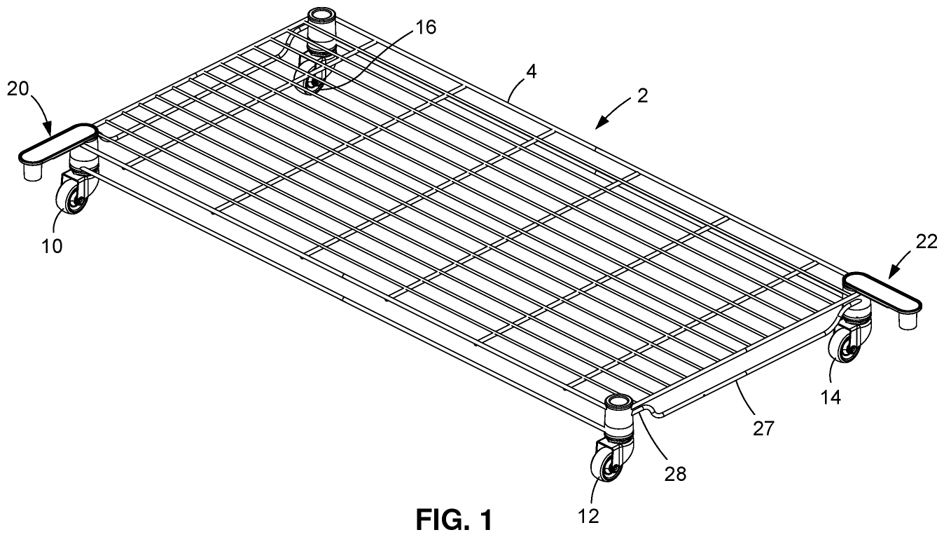

FIG. 1 is an isometric view of a rack 2 for a baker's dolly, in accordance with one non-limiting embodiment of the disclosed concept. The rack 2 has or defines a shelf, deck or support portion 4. Preferably, the rack 2 is movably supported, such as rollably supported by a plurality of casters or wheels/rollers 10,12,14,16 coupled to the deck 4. Further, the rack 2 may include at least one coupling member (e.g., link members 20,22).

The deck 4 is preferably generally planar and may have various configurations. In order to be lightweight, the deck 4 may have a wire-frame configuration. In another example, the deck 4 may have a closed or planar frame configuration (e.g., be solid). In one embodiment, the wire deck has an upper wire frame (e.g., such as at the periphery of the rack 2) with a plurality of cross-wires which cooperate to define the supporting deck 4. The wire deck may also include a plurality of lower wire frame elements. The lower wire frame elements may, for example, also be located at the periphery of the deck 4 and may be spaced apart (below) the upper wire frame. The lower wire frame elements may be connected to the upper wire frame, such as via one or more mounting portions 3 of the rack 2 (as described in more detail below), or in other manners.

As illustrated in FIG. 1, the lower wire frame elements (e.g., wire element 27) may include or define an inset or notch (e.g., inset 28, such as where the lower wire frame element bends inwardly towards the supper wire frame element), such as near the corners. As illustrated, the insets 28 might be located near the mounting portions 3 and ends of the rack 2 and allow the decks to be stacked in a nested, lower profile configuration, such as for shipping and storage (where, in a stacked configuration, a peripheral portion of the wire frame of one deck 4 may be aligned with and fit partially within an adjacent deck via alignment with the insets 28 or notches. In this manner, the stacked dimension of the racks 2 is reduced, allowing for a smaller packed size for the baker's rack of the invention during transport/shipping and storage/display, thus reducing the costs associated with those activities.

The deck 4 may also have various shapes and sizes. In one embodiment, the deck 4 is generally rectangular in shape, such as having a length which exceeds its width. However, the deck 4 could be, for example, square. In a configuration in which the decks 4 are rectangular, they may have a pair of opposing elongate sides and a pair of opposing shorter ends.

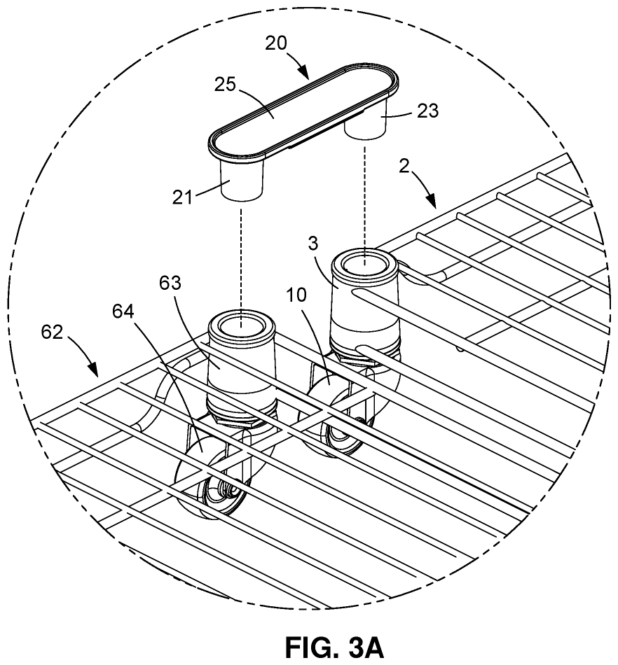

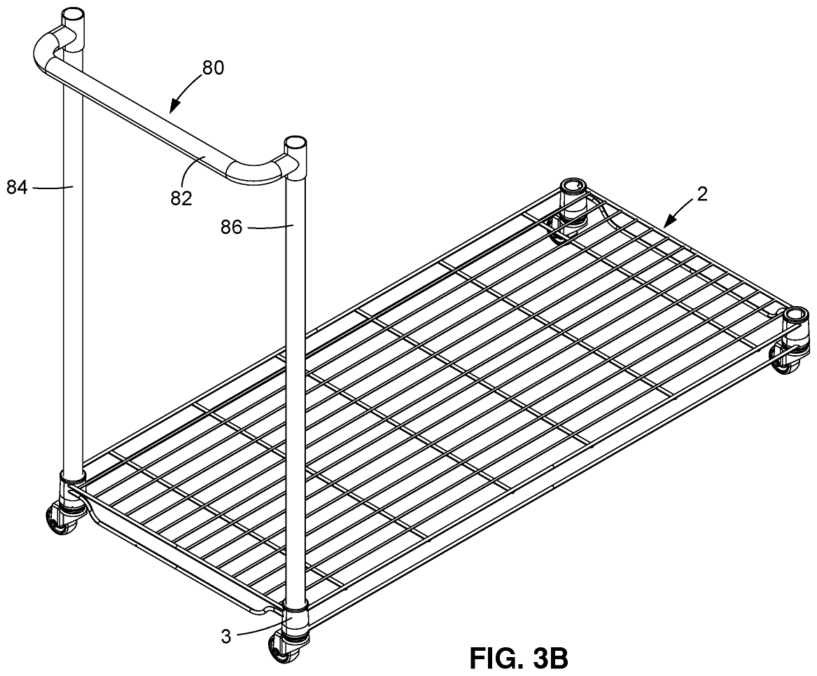

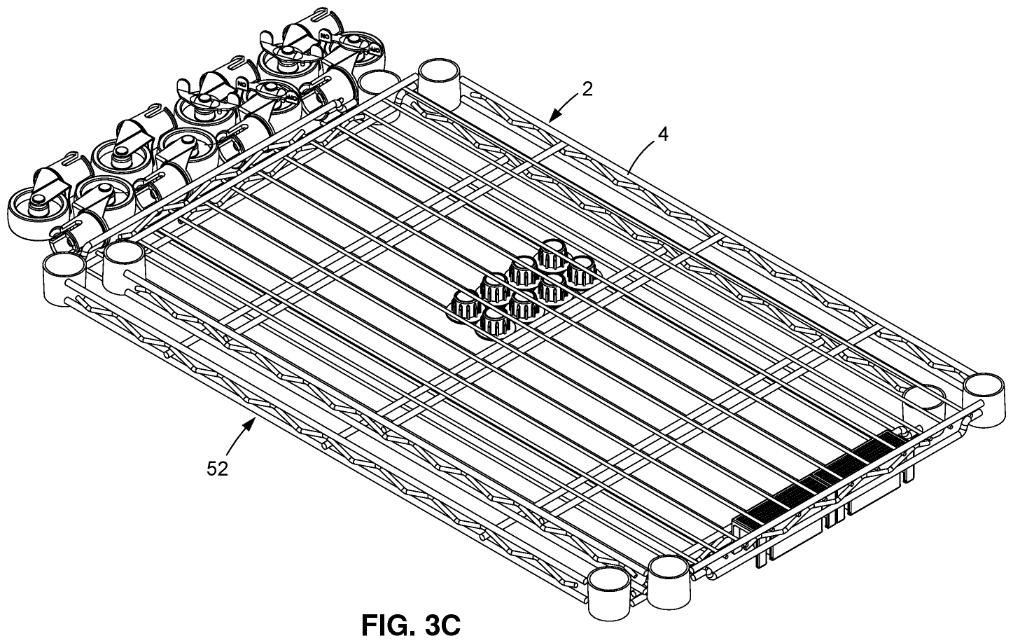

In one embodiment, the rack 2 has a plurality of mounting portions (one mounting portion 3 of the four mounting portions of the rack 2 is labeled in FIG. 3A). Accordingly, the mounting portions 3 may be located at the corners of the rack 2 (but may be located elsewhere, such as when the rack 2 is not quadrilateral in shape). In one embodiment, the mounting portions 3 may be configured as universal mounts which permit connection of a plurality of different elements thereto. For example, as described below, each mounting portion 3 may facilitate connection of a caster or wheel, a handle, a support and/or a rack connector. In one embodiment, the mounting portion 3 may be configured as a sleeve, such as having a body or wall with a passage through, which is oriented generally vertically. In one preferred configuration, the body or wall is cylindrical in shape.

In one embodiment, the casters 10,12,14,16 are used to rollably support the deck 4. In one embodiment, one caster 10,12,14,16 is located at each corner of the deck 4 when the deck 4 is quadrilateral in shape, such as by connection to one of the mounting portions 3. However, other numbers of casters might be utilized and they might have other locations (such as along the sides, etc.; the number of casters might be less than the number of mounting portions 3). The casters 10,12,14,16, such as a body thereof, may be removably connected to the deck 4. However, for strength and rigidity, the casters 10,12,14,16 may be formed as a portion of the deck 4, such as where wire frame elements thereof are molded as part of, or welded, etc., to a body of the caster.

In one configuration, the casters 10,12,14,16 may be removably connected to the deck 4. Further, one or more of the casters 10,12,14,16 preferably includes a means for receiving or means for mounting. The means for receiving may comprise a generally cylindrical receiving portion of the caster, such as at a top thereof, which portion may be configured to receive a mating member in sliding relationship thereover, or within an opening defined thereby, as further described below. As described in more detail below, in one embodiment, the receiving portion may be defined by an insert which is coupled to the caster.

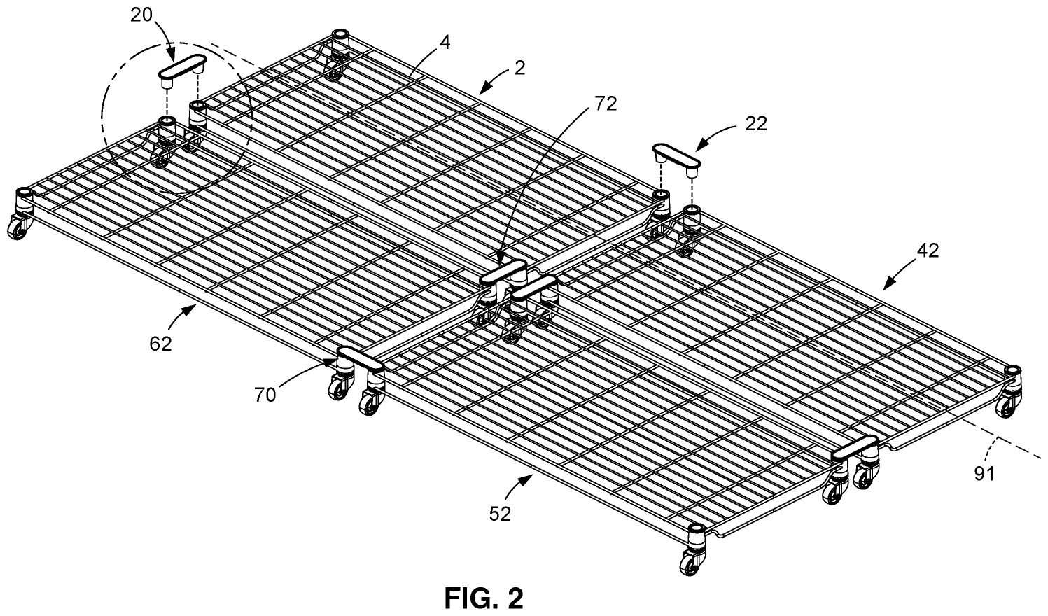

In accordance with the disclosed concept, link members 20,22 are configured to couple one rack 2 to another rack, such as to provide for a modular baker's dolly. See, for example, FIG. 2, which shows a plurality of racks 2,42,52,62 (e.g., the racks 42,52,62 are configured the same as the rack 2) of a baker's dolly coupled together via link members 20,22,70,72 (and other link members shown but not labeled), and FIG. 3A, which shows an enlarged portion of FIG. 2. As shown in FIG. 2, link members 20,22 couple rack 2 to racks 62,42, respectively, preferably by joining the racks at the casters (and more specifically, the mounting portions 3), and extending into and coupling to mounting portions of the racks 62,42 via press or snap-fit mechanisms. Similarly, link members 70,72 couple rack 62 to racks 52,2, respectively in a similar manner.

In this manner, the baker's dolly including racks 2,42,52,62 is advantageously configured to be significantly more modular than prior art baker's dollies in that the link members 20,22,70,72 allow each of the racks 2,42,52,62 to be rolled in a common horizontal plane. For example, while prior art baker's dollies may be configured to be stackable, e.g., one rack on top of another, the baker's dolly including racks 2,42,52,62 is provided with lateral means for significantly more racks to be employed in transport, thus allowing more load (e.g., without limitation, bags of food, tools, parts, etc.) to be transported. Furthermore, the modularity provided by the link members 2,22,70,72 allows for variable coupling, e.g., the racks 2,42 are positioned along a common longitudinal axis 91 (e.g. end to end), and the racks 2,62 are each positioned side by side in a lateral direction (e.g. side by side), or in combinations thereof.

As shown in FIG. 3A, the link member 20 has first and second coupling portions (e.g., cylindrical-shaped portions 21,23), and a body portion 25 extending therebetween. In operation, first and second cylindrical-shaped portions 21,23 are configured to extend into and couple to mounts or mounting portions 3,63 of racks 2,62 via either a press-fit or snap-fit mechanism in order to couple the racks 2,62 to each other. In one example, the link member 20 is removably coupled to each of the mounting portions 3,63. Furthermore, in the example of FIG. 3A, the caster 10 is coupled to the mounting portion 3 and a caster 64 of the rack 62 is coupled to the mounting portion 63 of the rack 62. Thus, the coupling portions 21,23 may couple to the casters 10,64 in any suitable manner, e.g., press fit mechanism, snap-fit mechanism, etc. Additionally, link member 20 (and link members 22,70,72) may be made of any suitable material, e.g., metal, monomeric, and/or polymeric materials. In one configuration, the first and second cylindrical-shaped portions 21,23 are generally cylindrical and are designed to slip or fit into the receiving portions of the casters, or into the top opening of the mounting portion 3 of the rack 2.

FIG. 3B shows another aspect of the baker's dolly, in accordance with the disclosed concept. As shown, the baker's dolly includes the rack 2, discussed above, coupled to a handle 80. It will be appreciated that the handle 80 advantageously allows a user to transport a load (e.g., bags of food) without having to bend over and push the load during transport. In other words, in accordance with the baker's dolly of the disclosed concept, a user can simply push or pull the handle 80 in order to move the load. In one embodiment, the handle 80 is generally “U” shaped, having a gripping portion 82 and a pair of extension portions 84,86 each extending downwardly therefrom at approximately a 90-degree angle and having first and second ends, respectively, that are each located within and coupled to corresponding first and second mounting portions (e.g., mounting portion 3 is labeled in FIG. 3B) of the rack 2.

FIG. 3C is an isometric view of two racks 2,52 for the baker's dolly directly stacked on top of one another, such as for shipping or storage. In such a configuration, the decks 4 of the racks 2,52 may be positioned directly on top of one another, but preferably where one rack 52 is inverted relative to the other rack 2, and where the racks are slightly offset. This allows, as illustrated, one of the side rails of the top rack 2 to fit into the notches or insets (see notch 28 in FIG. 1) at the end of the bottom rack 52 (the opposing side rail of the top rack 2 extends slightly outwardly of the side of the bottom rack 52, but where that side rail of the bottom rack 52 then fits into the corresponding notch at one end of the top rack 2), thus allowing the racks 2,52 to be stacked closer together/with a lower depth profile (thus reducing the packaging size). Additional components, such as casters and link members, may be packed between the racks 2,52 without the racks 2,52 disengaging along the perimeter. Furthermore, shipment and storage of the racks 2,52 and components therebetween is significantly simplified when the racks 2,52 are in this position.

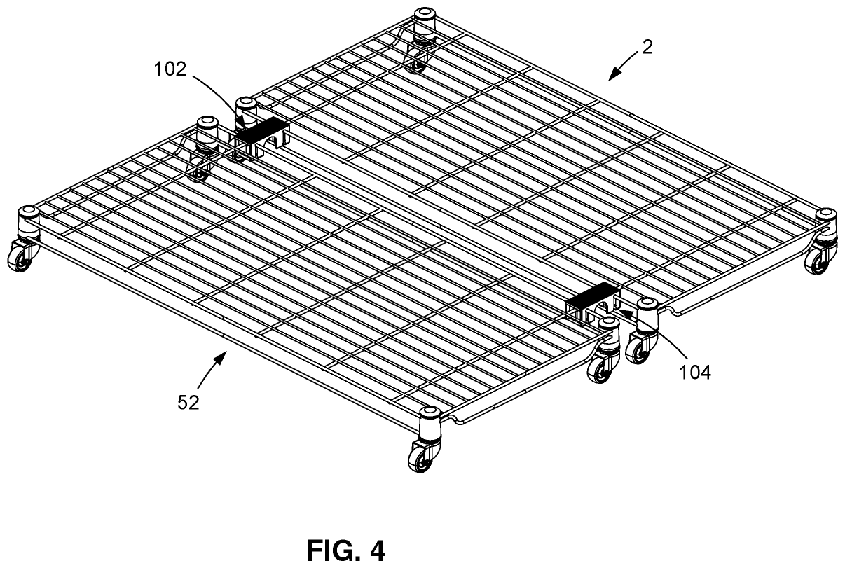

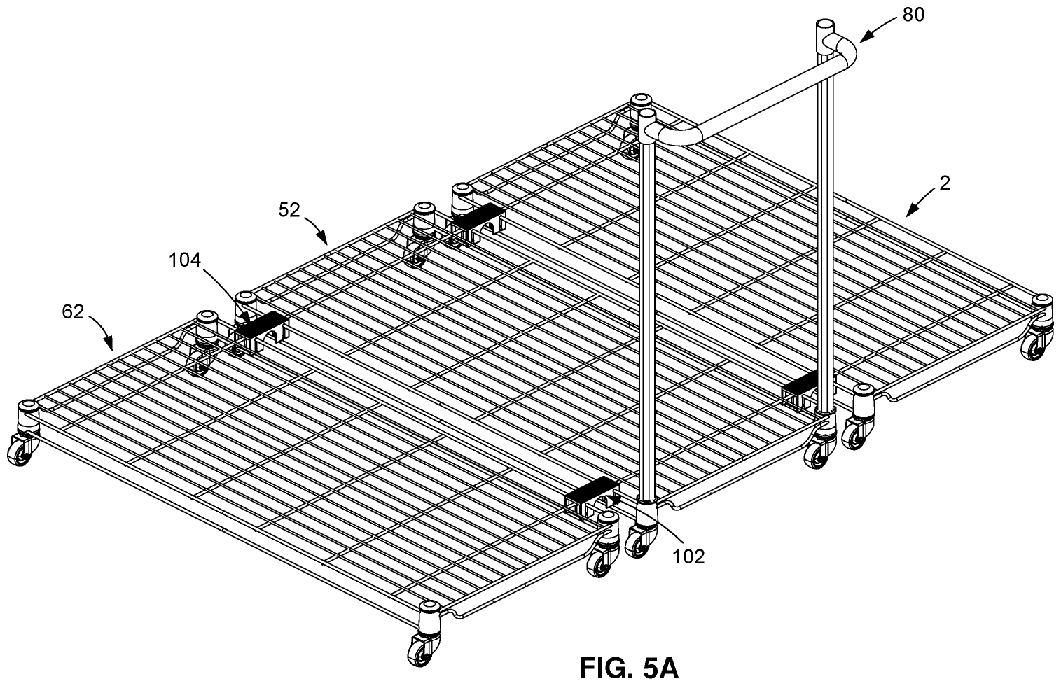

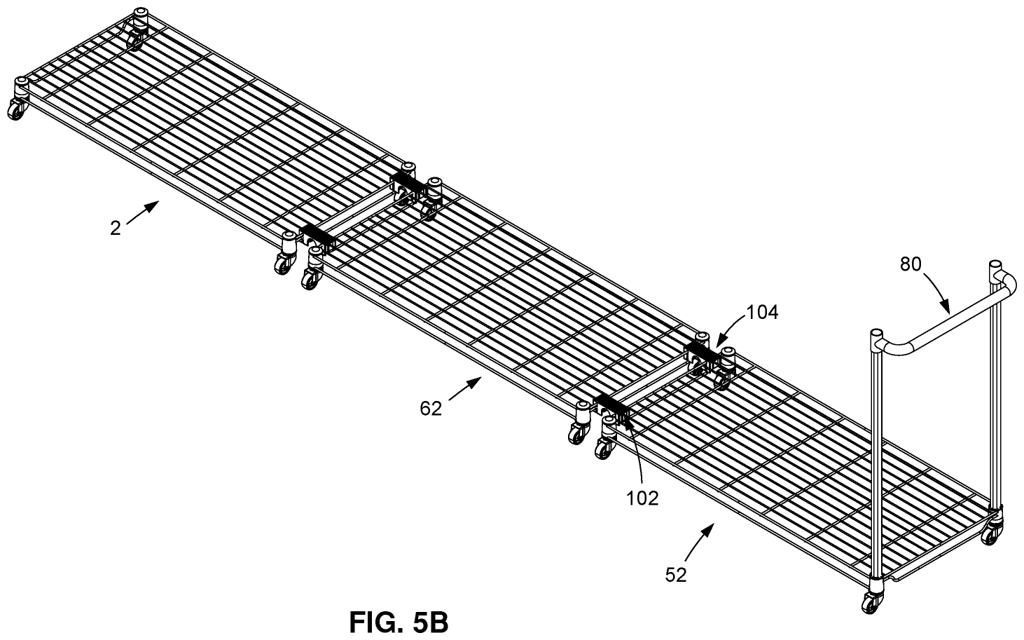

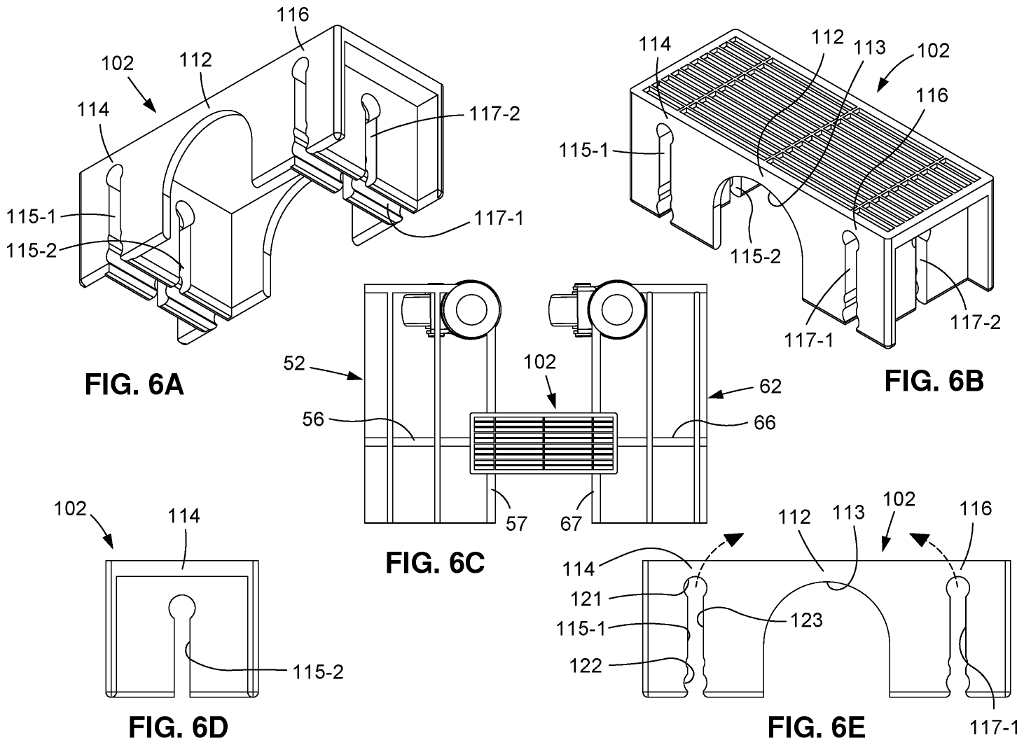

FIGS. 4 and 5 show different configurations of another baker's dolly. FIG. 4 shows the racks 2,52 coupled together via a number of other coupling members (two example coupling members 102,104 are shown in FIG. 4), in a lateral or side-by-side configuration. See also FIGS. 6A-6E for other views of the coupling member 102. It will also be appreciated that the racks 2,52, or suitable alternative racks, may be coupled together in a longitudinal manner via the coupling members 102,104. FIG. 5A shows the racks 2,52,62 all coupled together in a side-by-side lateral orientation and coupled together via four coupling members (two coupling members 102,104 are indicated and are configured the same as each other), and FIG. 5B shows the racks 2,52,62 coupled together with the coupling members 102,104 in a longitudinal manner. Furthermore, as shown in FIGS. 5A and 5B, handle 80 is coupled to the rack 52, and is thus configured to roll all three racks 2,52,62 of the baker's dolly in a simple and easy push/pull manner. Accordingly, it will be appreciated with reference to FIGS. 4, 5A, and 5B that the racks 2,52,62, as well as additional racks, can be coupled in a plurality of different configurations wherein the racks 2,52,62 are all on the same horizontal plane (e.g., on the ground in FIGS. 4, 5A, and 5B).

As illustrated in these figures, the link members 20,22 and the coupling members 102,104 may be used to connect two or more racks. However, another embodiment of the invention comprises the novel coupling members 102,104, which will now be described in detail, and which permit the racks to be coupled in a different manner (e.g. other than by joining them at the casters).

As shown in FIGS. 6A-6E, the coupling member 102, is preferably made of a monomeric, polymeric, or material mixture thereof (e.g., plastic) so that it is flexible and lightweight. Furthermore, the coupling member 102 may have a top and a pair of downwardly extending sides, plus one or more walls members between the sides. As illustrated, the coupling member 102 may include a central portion 112 and a pair of end portions 114,116 extending from the central portion. The central portion 112 may define a generally semi-circular shaped cutout region 113 in the opposing sides thereof to allow the coupling member 102 to flex. See, for example, FIG. 6E, which shows directions that the coupling member 102 is designed to flex, such as to flex when being coupled to racks 2,52 (FIGS. 4, 5A, and 5B).

Referring to FIG. 6A, the end portions 114,116 each have at least one slot 115-1,115-2,117-1,117-2 for allowing the coupling member 102 to couple the racks 52,62 (FIGS. 5A and 5B) together. The slots 115-1,115-2,117-1,117-2 may include first and second perpendicularly oriented slots 115-1,115-2 provided with the first end portion 114 and first and second perpendicularly oriented slots 117-1,117-2 provided with the second end portion 116. In this manner, as shown in FIG. 6C, the slots 115-1,117-1 can receive wire elements 57,67 of racks 52,62, and the slots 115-2,117-2 can receive wire elements 56,66 of racks 52,62. Thus, the coupling member 102 is configured to be employed with the racks 52,62 without any modification needed to the racks 52,62, e.g., notice that the wire elements 56,66 are oriented perpendicular to the wire elements 57,67 and are thus configured to be received by the perpendicularly-oriented slots 115-1,115-2,117-1,117-2.

Additionally, in one example, as shown in FIG. 6E, the slot 115-1 has a first grooved region 121, a second grooved region 122 located opposite the first grooved region 121, and a linear region 122 extending therebetween. It will be appreciated that the first and second grooved regions 121,122 are each configured to receive one of the wire elements of the rack 52 in a press-fit or snap-fit manner. Furthermore, the slot 117-1 is similarly configured, and the slots 115-2,117-2 may optionally be configured with one grooved region and one linear region.

When the coupling member 102 is coupled to the racks 2,52, the central portion 112 may be flexed in the manner depicted in FIG. 6E, and the grooved cutout regions 115,117 may each be inserted around a rail or other portion of the racks 2,52, thereby preventing undesirable movement of the rack 2 with respect to the rack 52 (FIGS. 4, 5A, and 5B). Additionally, it will be appreciated with reference to FIG. 6C that the rectangular profile of the coupling member 102 ensures that the dollies are fixed side by side, and snap around the wire frame of the various sizes. Moreover, there is a slight cavity at each of the end portions 114,116 to provide additional groove rigidity. Specifically, the pattern at the top of the coupling member 102 is configured to mimic the wire decking.

It will also be appreciated with reference to FIG. 6C that the depth of the unit is equal to the spacing that is normally seen between the wires that are applied to the top of the platforms. Thus, the cutout region 113 of the central portion 112 and the slots 115-1,115-2,117-1,117-2 of the end portions 114,116 advantageously prevent the coupling member 102 from moving side to side in operation. FIG. 6D shows another view of the end portion 114, wherein the slot 115-2 is configured to snap around the wire platform decking. Additionally, because the coupling member 102 is configured to flex, a rubber and/or plastic material, or other monomeric, polymeric, or material mixture thereof may be preferable to provide for this function. Note that the large notch in the locking link allows the two dolly platforms to pivot up and down over a surface that is not level while keeping the groove applied to the ends of the coupling member secured to the main wire platform body. Of course, the coupling member 102 might have other configurations to permit such movement, such as by being flexible in the central portion thereof, being hinged, etc.

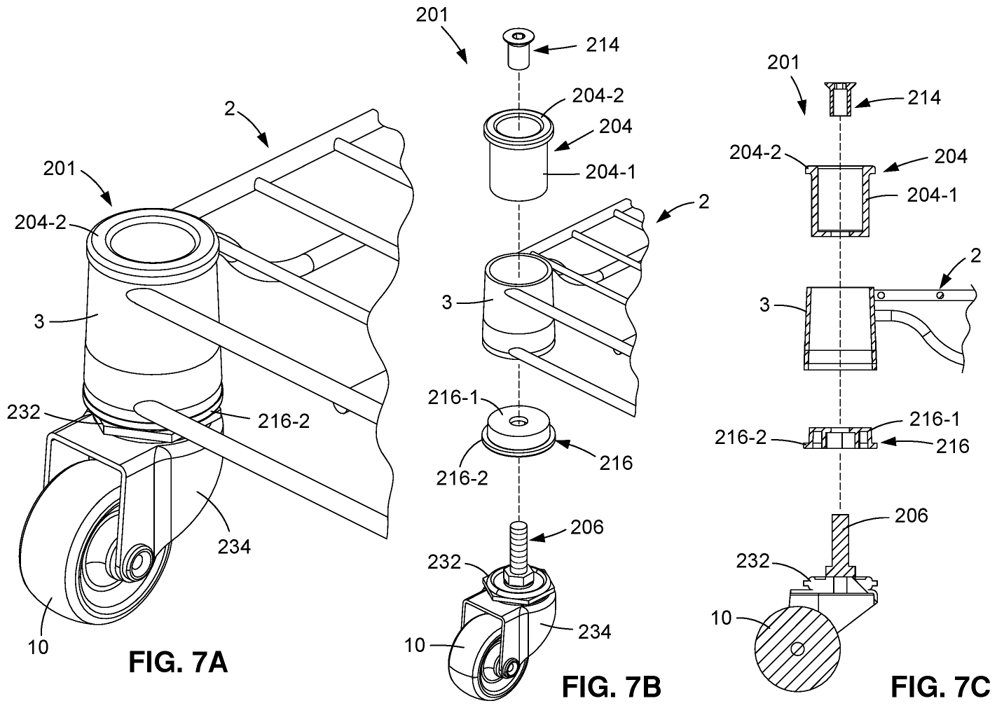

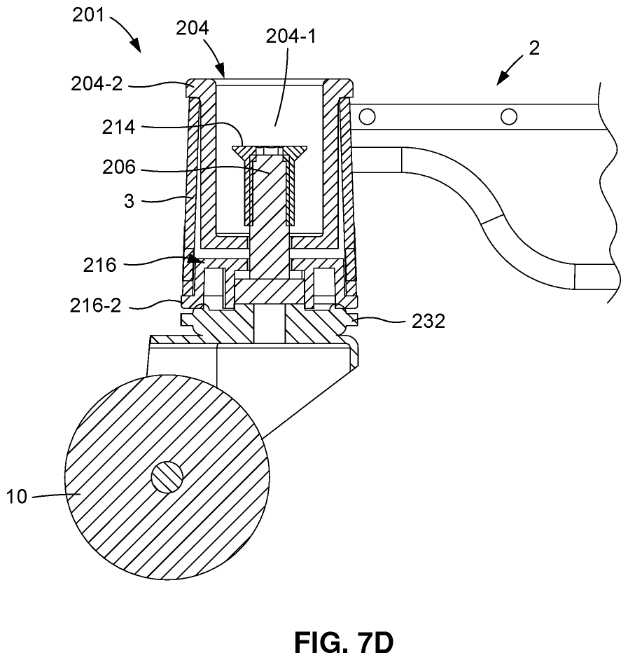

FIGS. 7A-7D show different aspects associated with casters for the baker's dolly. In one configuration, the baker's dolly includes an interconnect assembly 201 for connecting a caster 10 to the mounting portion 3. The caster 10 includes a wheel, a casing member 234 coupled to the wheel, and a bolt 206 coupled to the member 234. The interconnect assembly 201 includes an insert 204 and a nut 216. The insert 204 may be connected to (such as by welding) or formed with the wire deck. The wheel of the caster 10 may then be connected to and supported by, the insert 204. The insert 204 may also comprise or define the means for receiving, such as of the links, handle, etc. described above, or such may be defined by an insert which is located in or coupled to the collar, as described below. The insert 204 is configured to receive the bolt 206 therethrough and extend partially into the mounting portion 3. In one example, the insert 204 includes a body portion 204-1 and a rim 204-2 extending radially outwardly from the body portion 204-1. Additionally, the nut 216 is configured to receive the bolt 206 therethrough and extend partially into the mounting portion 3. Furthermore, the nut 206 preferably includes a body portion 216-1 and a rim 216-2 extending radially outwardly from the body portion 216-1. As shown most clearly in FIGS. 7A and 7D, the rims 204-2,216-2 are located parallel to one another in order to receive the mounting portion 3 therebetween and be coupled to the mounting portion 3.

Additionally, and continuing to refer to FIGS. 7A-7D, in one example the interconnect assembly 201 further includes another insert 214 configured to be threadably coupled to the bolt 206 such that rotation of the insert 214 with respect to the insert 204 and the nut 216 (e.g., and also the bolt 206) moves the rim 204-2 of the insert 204 toward the rim 216-2 of the nut 216 in order to couple the insert 204 and the nut 216 to the mounting portion 3. Thus, a simple and reliable mechanism for coupling the caster 10 to the mounting portion 3 is provided such that all a user needs to do is align the insert 204 and the nut 216 on opposing sides of the mounting portion 3, each with the bolt 206 extending therethrough, and then tighten the insert 214 with respect to the bolt 206 (e.g., and also the nut 216 and the insert 204) until the rims 204-2,216-2 sandwich the mounting portion 3 therebetween. As such, and continuing to refer to FIGS. 7A-7C, a nut 232 of the interconnect assembly 201 located on the caster 10 aligns with a bottom portion of the insert 214 in order to allow the nut 216 on the top to be tightened. In this manner, the load of rack 2 will be directly applied to the nut 232, which is configured to prevent the casing member 234 of the caster from taking any of the weight. Furthermore, as shown, a top of the insert 204 at the rim 204-2 has a receiving portion configured to receive, for example, one of the cylindrical-shaped portions 21,23 (FIG. 3A) and/or one of the ends of the handle 80 (FIG. 3B). The interconnect assembly 201 is thus modular in order to allow for both coupling of the caster 10 as well as additional components of a baker's dolly on a top side thereof.

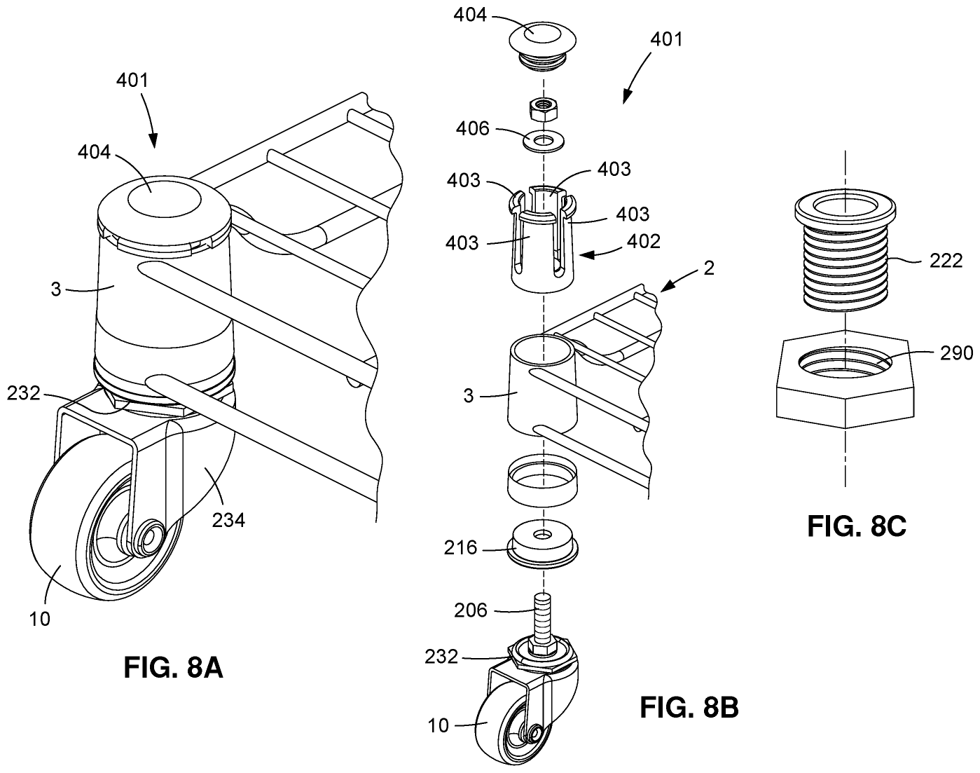

In yet another example, as shown in FIGS. 8A and 8B, wherein like numbers represent like features from FIGS. 7A-7D, the body portion of the insert 402, which functions substantially the same as the insert 204, has a plurality of tines (e.g., flexible elongated members) 403 that are each configured to flex radially inwardly and outwardly in order to receive a collar member. Furthermore, in the example of FIGS. 8A and 8B, a cap 404 is provided with the interconnect assembly 401 and is configured to cause the tines 403 to flex outwardly such that the cap 404 is received between and coupled to a center of the tines 403 via a press-fit mechanism, thereby providing for a sleek appearance of the baker's dolly.

In the example of FIGS. 8A and 8B, the insert 402 is a single push-in insert 402 that can be molded around an existing caster/wheel assembly stud and/or be used by placing a threaded stud through a hole on the bottom with a washer/nut applied. The bottom may have a molded nut profile that prevents the bolt from turning during assembly. After the assembly of the push-in insert 402 with washer/nut, the cap 404 can be placed on top of the insert 402 to prevent the tines 403 from being bent and broken, and also to finish the look of the corner of the rack/top of the caster while also providing a surface for the item to be placed on top of the dolly to rest. It will also be appreciated that the scale of the insert 402 can be increased or decreased to match wire decking steel collars of different sizes. Moreover, the center of the push in insert 402 is made to match that of a standard washer 406. Accordingly, washers are configured to fit in both large and small collars, in accordance with the disclosed concept.

In yet a further example, as shown in FIG. 8C, wherein like numbers represent like features from FIG. 8B, the insert 222 is threadably coupled to the nut 290, thus advantageously providing for a mechanism wherein a separate insert (e.g., the insert 214 from FIGS. 7A-7D) is not needed.

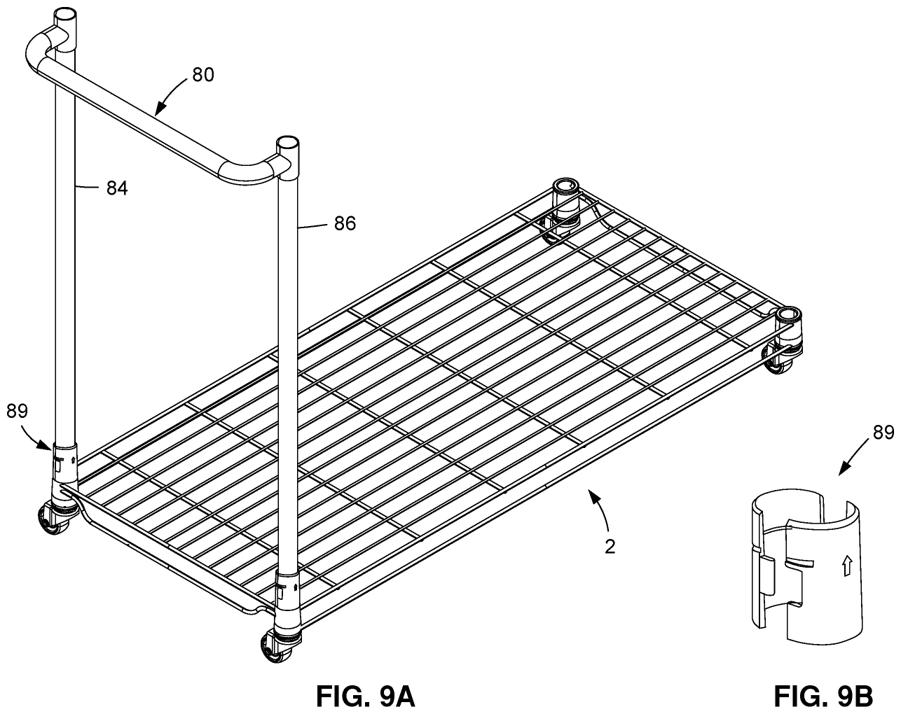

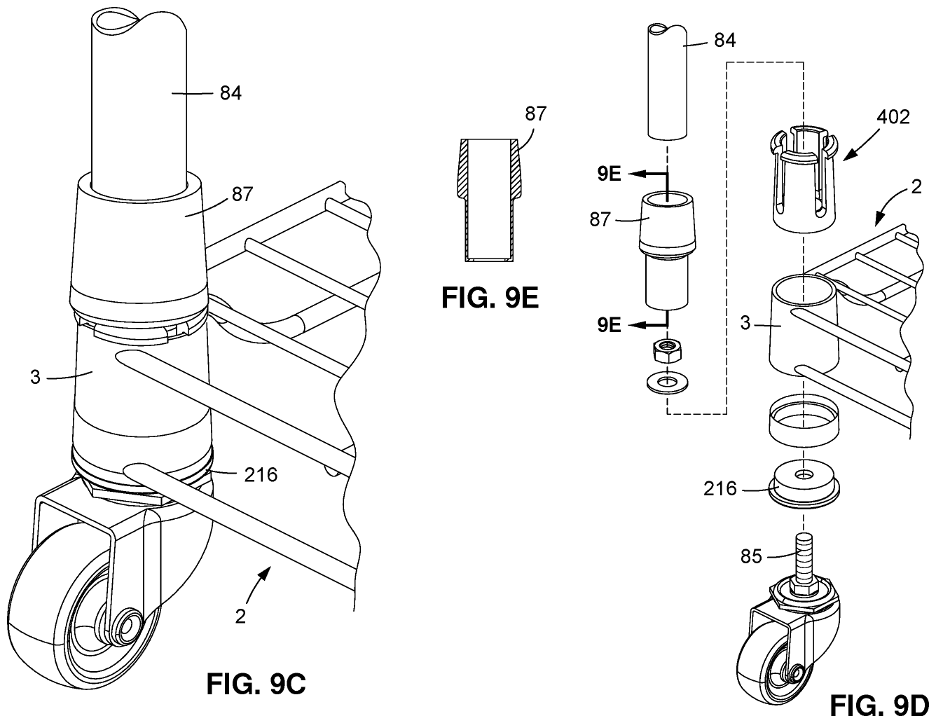

FIG. 9A shows the handle 80 coupled to the rack 2. As shown, the extension portion 84 may have a metallic slug applied like traditional baker style racking, and may further have an internal threaded bore that screws onto a caster threaded rod or stud 85 (FIG. 9D) that protrudes through the plastic push in collar 87. FIG. 9E shows a section view of the handle collar 87, which gives additional strength to the handle 80. The collar 87 has a slight lip on the underside of the tube that prevents it from sliding up the extension portion 84 (FIGS. 9C and 9D). Furthermore, it will be appreciated with reference to FIG. 9B that an internal groove can be added to the inner portion of the collar 87 as well to help it lock on the extension portion 84, but would however need to be broken into two pieces 89 like the traditional baker's rack locking collar for assembly reasons.

While in a preferred embodiment, the handle 80 is configured to mount to an insert 402 which is associated with a caster, the handle 80 could be directly connected (or connected by other connectors) to mounting portions 3 of the rack 2 (e.g. which do not necessarily have a caster mounted thereto as well).

In one embodiment, the mounting portions 3 might be utilized to facilitate connection of other elements. For example, vertical risers or struts might be inserted into the mounting portions 3 or one riser 2 and be used to support another rack 2 there above (e.g. in a spaced, stacked configuration).

As indicated herein, elements may be mounted to the mounting portions 3 in various manners, such as, but not limited to a compression connection where a member located at the top of the mounting portion 3 is connected to a member located at the bottom of the mounting portion and the two members are pulled towards one another—such as by threading (e.g. the members directly engage), a separate nut/bolt or, other connection of the top and bottom members, etc., or via compression of the element into or onto the mounting portion 3. In yet other embodiments, elements might be connected to the mounting portions 3 by fasteners, such as one or more threaded fasteners which extend through the wall of the mounting portion 3 into engagement with the element to be connected, etc.

In a preferred embodiment, the mounting portions 3 are configured to accept elements therein, such as into the internal passage therethrough. However, elements might be mounted to the mounting portions 3 in other manners. For example, when the mounting portion 3 comprises a cylindrical mount, an element might be mounted over the top and/or bottom thereof, in a connecting relationship. For example, a cylindrical sleeve might have a bottom portion thereof mounted over the top of a mounting portion 3 and be configured to receive the bottom of one of the extension portions 84 of the handle 80 therein, thereby coupling the handle to the mounting portion and thus the rack 2.

As indicated, the caster mount and handle mount features may be used with racks of other configurations, such as by associating them with sleeves thereof. It will be appreciated that aspects of the invention comprise methods and devices for rollably supporting and moving dollies or racks, and for connecting or associating racks with one another in various configurations to permit larger loads to be transported. Additional aspects of the invention comprise such racks with improvements which enable them to be packed, shipped and stored with less weight and size.

This description uses examples to describe embodiments of the disclosure and also to enable any person skilled in the art to practice the embodiments, including making and using any devices or systems and performing any incorporated methods. The patentable scope of the disclosure is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A baker's dolly comprising:
a plurality of racks each comprising a shelf portion and a plurality of casters coupled to the shelf portion, the plurality of racks comprising a first rack and a second rack; and
at least one coupling member coupling the first rack to the second rack in order to allow each of the first and second racks to each be rolled in a common horizontal plane.

2. The baker's dolly according to claim 1, wherein the first rack and the second rack each comprise a mount, wherein the plurality of casters of the first rack comprises a first caster coupled to the mount of the first rack, wherein the plurality of casters of the second rack comprises a second caster coupled to the mount of the second rack, and wherein the at least one coupling member comprises a link member extending into the mount of the first rack and the mount of the second rack in order to couple the first rack to the second rack.

3. The baker's dolly according to claim 2, wherein the link member comprises first and second cylindrical-shaped coupling portions, and a body portion extending therebetween, and wherein the first and second coupling portions are configured to extend into and couple a corresponding one of the mount of the first rack to the mount of the second rack via either a press-fit or snap-fit mechanism.

4. The baker's dolly according to claim 3, wherein the first and second racks are each positioned along a common longitudinal axis.

5. The baker's dolly according to claim 3, wherein the first and second racks are each positioned side by side in a lateral direction.

6. The baker's dolly according to claim 3, wherein the link member is a first link member, wherein the baker's dolly further comprises a third rack, a fourth rack, a second link member, a third link member, and a fourth link member, wherein the second link member is configured to extend into and couple a corresponding mount of the third rack to a corresponding mount of the fourth rack via either a press-fit or snap-fit mechanism, wherein the third link member is configured to extend into and couple another corresponding mount of the first rack to a corresponding mount of the third rack either a press-fit or snap-fit mechanism, and wherein the fourth link member is configured to extend into and couple another corresponding mount of the second rack to a corresponding mount of the fourth rack either a press-fit or snap-fit mechanism.

7. The baker's dolly according to claim 1, wherein the at least one coupling member comprises a first coupling member having a central portion, and a first end portion and a second end portion each extending from the central portion, and wherein each of the first and second end portions has at least one slot for allowing the first coupling member to couple the first rack to the second rack.

8. The baker's dolly according to claim 7, wherein the first and second racks each have a wire-frame configuration, and wherein the at least one slot comprises a first slot and a second slot oriented perpendicular with respect to the first slot in order to allow each of the first and second end portions to receive perpendicularly-oriented wire elements of the first and second racks.

9. The baker's dolly according to claim 8, wherein the central portion defines a semi-circular shaped cutout region in order to allow the first coupling member to flex while the first and second end portions are coupled to the first and second racks.

10. The baker's dolly according to claim 8, wherein the at least one coupling member comprises a second coupling member configured the same as the first coupling member, wherein the plurality of racks further comprises a third rack having a wire-frame configuration, and wherein the first and second slots of the first and second end portions of the second coupling member allow each of the first and second end portions of the second coupling member to receive perpendicularly-oriented wire elements of the first and third racks.

11. The baker's dolly according to claim 8, wherein at least one of the first and second slots of each of the first and second end portions comprises a first grooved region, a second grooved region disposed opposite the first grooved region, and a linear region extending therebetween, and wherein the first and second grooved regions are each configured to receive one of the wire elements of the first and second racks in a press-fit or snap-fit manner.

12. The baker's dolly according to claim 1, further comprising a U-shaped handle having a first end and a second end, wherein the first rack comprises a first mount and a second mount, and wherein the first and second ends are each disposed within and coupled to a corresponding one of the first and second mounts.

13. A baker's dolly comprising:
a caster comprising a wheel, a member coupled to the wheel, and a bolt coupled to the member;
a rack coupled to the caster, the rack having a mounting portion; and
an interconnect assembly comprising:
an insert configured to receive the bolt therethrough and extend partially into the mounting portion, the insert comprising a body portion and a rim extending radially outwardly from the body portion, and
a nut configured to receive the bolt therethrough and extend partially into the mounting portion, the nut comprising a body portion and a rim extending radially outwardly from the body portion of the nut,
wherein the rim of the insert and the rim of the nut are disposed parallel to one another in order to receive the mounting portion therebetween and be coupled thereto.

14. The baker's dolly according to claim 13, wherein the insert is a first insert, wherein the interconnect assembly further comprises a second insert threadably coupled to the bolt, and wherein, responsive to rotation of the second insert with respect to the first insert and the nut, the rim of the insert moves toward the rim of the nut in order to couple the first insert and the nut to the mounting portion.

15. The baker's dolly according to claim 13, wherein the insert is threadably coupled to the nut.

16. An interconnect assembly for a baker's dolly, the baker's dolly comprising a caster and a rack coupled to the caster, the caster comprising a wheel, a member coupled to the wheel, and a bolt coupled to the member, the rack having a mounting portion, the interconnect assembly comprising:
an insert configured to receive the bolt therethrough and extend partially into the mounting portion, the insert comprising a body portion and a rim extending radially outwardly from the body portion; and
a nut configured to receive the bolt therethrough and extend partially into the mounting portion, the nut comprising a body portion and a rim extending radially outwardly from the body portion of the nut,
wherein the rim of the insert and the rim of the nut are disposed parallel to one another in order to receive the mounting portion therebetween and be coupled thereto.

17. The interconnect assembly according to claim 16, wherein the insert is a first insert, wherein the interconnect assembly further comprises a second insert configured to be threadably coupled to the bolt, and wherein, responsive to rotation of the second insert with respect to the first insert and the nut, the rim of the insert moves toward the rim of the nut in order to couple the first insert and the nut to the mounting portion.

18. The interconnect assembly according to claim 16, wherein the insert is threadably coupled to the nut.

19. The interconnect assembly according to claim 16, wherein the body portion of the insert comprises a plurality of tines each configured to flex radially inwardly and outwardly in order to receive a collar member.

20. The interconnect assembly according to claim 19, further comprising a cap coupled to a center of the insert via a press-fit mechanism.
